(19) United States
(12) Patent Application Publication
(10) Pub. No.: US 2026/0180683 A1
(43) Pub. Date: Jun. 25, 2026

(54) OPTICAL COMMUNICATION ASSEMBLY WITH INTERNAL PLANAR OPTICAL ELEMENT AND OPTICAL COATING

(71) Applicant: VIAVI Solutions Inc., Chandler, AZ (US)

(72) Inventors: William D. HOUCK, Santa Rosa, CA (US); Markus BILGER, Santa Rosa, CA (US)

(21) Appl. No.: 19/423,101

(22) Filed: Dec. 17, 2025

Related U.S. Application Data
(60) Provisional application No. 63/738,131, filed on Dec. 23, 2024.

(51) Int. Cl. H04B 10/112; G02B 1/00; G02B 1/10; H04B 10/118; H04B 10/532; H04B 10/548

(52) U.S. Cl. CPC H04B 10/112; G02B 1/002; G02B 1/10; H04B 10/118; H04B 10/532; H04B 10/548

(57) ABSTRACT

An optical communication assembly includes a housing having an aperture and a planar optical element disposed within the housing. The planar optical element is positioned along an optical signal path, the planar optical element being located away from and not adjacent to the aperture. The optical communication assembly further includes an optical coating disposed on a surface of the planar optical element, the optical coating including a narrowband transmission region and a broadband blocking region configured to attenuate optical signals outside the narrowband transmission region.

### CROSS-REFERENCE TO RELATED APPLICATION

This Patent Application claims priority to U.S. Patent Application No. 63/738,131, filed on Dec. 23, 2024, and entitled “OPTICAL DEVICE WITH INTEGRATED SOLAR REJECTION FILTER.” The disclosure of the prior Application is considered part of and is incorporated by reference into this Patent Application.

### BACKGROUND

Optical communication assemblies are widely used to facilitate transmission of data using light signals. Effective handling of optical signals within these assemblies is essential to ensure reliable data transfer.

### SUMMARY

In some implementations, an optical communication assembly includes a housing having an aperture; a planar optical element disposed within the housing and positioned along an optical signal path, the planar optical element being located away from and not adjacent to the aperture; and an optical coating disposed on a surface of the planar optical element, the optical coating having a diameter that is less than a diameter of the aperture.

In some implementations, an optical communication assembly includes a housing having an aperture; a planar optical element disposed within the housing and positioned along an optical signal path, the planar optical element being located away from and not adjacent to the aperture; and an optical coating disposed on a surface of the planar optical element, the optical coating including a narrowband transmission region and a broadband blocking region configured to attenuate optical signals outside the narrowband transmission region.

In some implementations, an optical communication assembly includes a planar optical element disposed within a housing and positioned along an optical signal path, the planar optical element being located away from and not adjacent to an aperture of the housing; and an optical coating disposed on a surface of the planar optical element, the optical coating including a narrowband transmission region.

### BRIEF DESCRIPTION OF THE DRAWINGS

FIG. 1 is a diagram of an example implementation associated with an optical communication assembly with an internal planar optical element and optical coating.

FIGS. 2A-2B are diagrams of example implementations associated with an optical communication assembly with an internal planar optical element and optical coating.

### DETAILED DESCRIPTION

The following detailed description of example implementations refers to the accompanying drawings. The same reference numbers in different drawings may identify the same or similar elements.

Optical communication systems, such as those used in satellite and free-space optical communication (FSOC) systems, typically rely on one or more optical elements to transmit and receive optical signals. These systems may include an aperture, aperture optics, and routing optics to direct optical signals along a defined path within a housing. In many applications, it is necessary to reject unwanted light, such as solar radiation, that can interfere with the desired communication signals. Broadband rejection filters, such as solar rejection filters (SRFs), are often employed to block unwanted light and are commonly positioned at or within the aperture to block unwanted solar radiation from entering the housing.

However, such broadband rejection filters need to be quite large to cover a full diameter of the aperture, which can result in increased manufacturing complexity and overall system weight. Integration of broadband rejection filters onto curved optical surfaces, such as refractive lenses, present additional challenges and are not a practical alternative. Applying high-performance optical coatings to curved surfaces is difficult, as the curvature introduces variations in an angle of incidence of incoming light across the surface, leading to non-uniform filter performance and increased complexity in a coating process.

Furthermore, any addition of separate optical filter components to the optical assembly increases a number of elements in the system, which can negatively impact reliability, increase assembly complexity, and complicate system integration. As optical communication systems continue to evolve toward smaller and lighter designs, there is a need for approaches that address the challenges associated with filter integration, coating uniformity, component size, and overall system performance.

Some implementations described herein provide an optical communication assembly that includes a planar optical element within a housing. The planar optical element is positioned along an optical signal path away from an aperture of the housing (e.g., the planar optical element is not positioned at or within the aperture) and the planar optical element includes an optical coating on its surface, the optical coating having a diameter less than that of the aperture (e.g., because a diameter of the surface of the planar optical element is less than that of the aperture because of aperture optics between the aperture and the planar optical element that reduce a diameter of an incoming light beam). The planar optical element may comprise a diffractive optical element, a refractive element, or a metasurface, and may be configured to focus, collimate, diffract, or expand incoming optical signals, or impart a spatial or temporal phase change to wavefronts of the incoming optical signals. The optical coating may comprise a narrowband transmission region and a broadband blocking region, with transmission characteristics that remain substantially stable over a wide range of angles of incidence. In some implementations, the optical coating may comprise a solar rejection filter configured to transmit a communication wavelength band while blocking solar radiation outside that band.

In some implementations, at least one of the planar optical element or the optical coating may modify a polarization state of an optical signal. Additionally, the optical coating or the planar optical element may comprise tunable or switchable materials with properties that are adjustable electrically, thermally, or optically, and may include integrated resistive heaters for temperature control.

In this way, the optical communication assembly addresses challenges related to the integration of broadband rejection filters in optical communication systems. By utilizing a planar optical element positioned away from the aperture, a required area for broadband rejection filtering is reduced, thereby decreasing a mass and volume of filter material utilized in the optical communication assembly. Further, application of an optical coating to a flat surface facilitates increased uniformity of spectral transmission and rejection characteristics over a wide range of angles of incidence, and minimizes undesirable angle-dependent wavelength shifts. This improved uniformity and reduced wavelength shift result in more consistent filtering performance, which enhances a signal-to-noise ratio and ensures reliable operation of the optical communication assembly under varying optical conditions. Additionally, the integration of multifunctional features, such as polarization control, tunable filtering, and thermal management, enables a reduction in component count and interconnects, leading to increased assembly reliability and decreased risk of alignment errors, as well as improved thermal stability of optical characteristics.

As a result, these features provide improved assembly-level technical performance, including increased signal-to-noise ratio in an optical communication channel due to enhanced out-of-band rejection, reduced mass and volume of the optical communication assembly, and improved manufacturability through simplified planar coating processes. The optical communication assembly also exhibits greater environmental stability and versatility in optical communication applications, including satellite, terrestrial, and other FSOC systems.

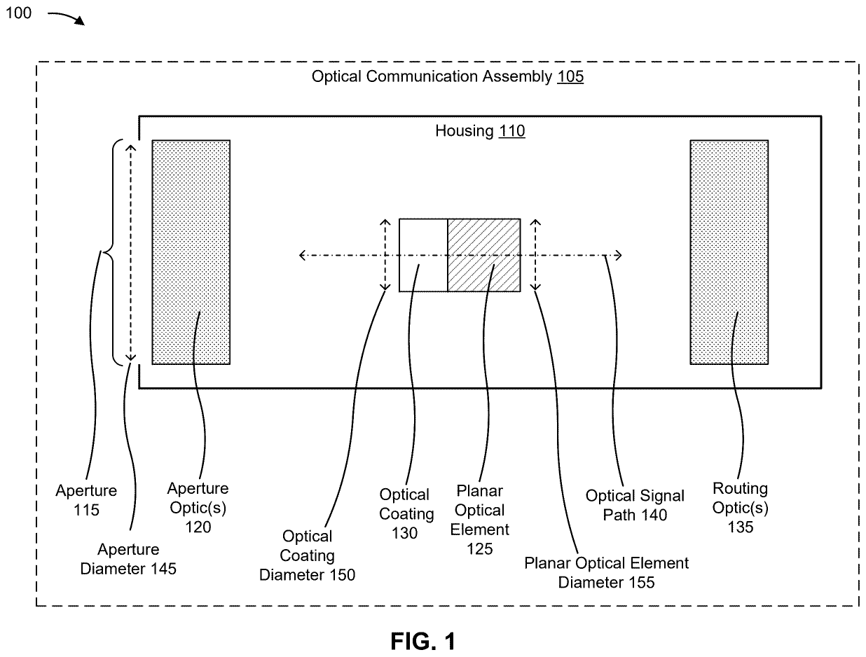

FIG. 1 is a diagram of an example implementation 100 associated with an optical communication assembly with an internal planar optical element and optical coating. As shown in FIG. 1, example implementation 100 includes an optical communication assembly 105, which can be used within an optical communication system to facilitate transmission and reception of optical signals in a variety of applications, including satellite, terrestrial, and/or FSOC applications. The optical communication assembly 105 includes a housing 110 that has an aperture 115, one or more aperture optics 120, a planar optical element 125, an optical coating 130, and/or one or more routing optics 135. The optical communication assembly 105 may be associated with an optical signal path 140. Further details of the optical communication assembly 105, the housing 110, the aperture 115, the one or more aperture optics 120, the planar optical element 125, the optical coating 130, the one or more routing optics 135, and the optical signal path 140 are provided herein.

As shown in FIG. 1, the housing 110 may define an enclosure for the optical communication assembly 105 and may provide structural support for various internal optical components described herein. In some implementations, the housing 110 may be configured for use in satellite, terrestrial, and/or FSOC systems. In this way, the housing 110 may facilitate integration into a wide range of optical communication applications.

As further shown in FIG. 1, the aperture 115 may define an opening in the housing 110 through which an optical signal enters or exits the optical communication assembly 105 and the housing 110. The aperture 115 may have a defined aperture diameter 145, or other dimensional parameter such as width, which establishes a maximum size of a light beam (e.g., that includes an optical signal) that can initially enter or exit the housing 110. In some implementations, the aperture 115 may be sized according to system requirements, such as desired field of view, signal collection efficiency, or transmission characteristics. In this way, the aperture 115 may enable efficient capture of incoming optical signals and/or efficient transmission of outgoing optical signals.

As further shown in FIG. 1, the one or more aperture optics 120 may be positioned within or adjacent to the aperture 115 within the housing 110 and may be configured to direct, focus, or otherwise manipulate incoming or outgoing optical signals along the optical signal path 140. As used herein, “within or adjacent” to the aperture 115 refers to optical elements that are either physically located inside a boundary of the aperture 115 or positioned immediately next to or in close proximity to the aperture 115, such that optical elements are able to interact with optical signals entering the housing 110 via the aperture 115 before any other optical element disposed within the housing 110, or with optical signals exiting the housing 110 via the aperture 115 after all other optical elements disposed within the housing 110. In some implementations, the one or more aperture optics 120 may comprise refractive, diffractive, or other types of optical elements, and/or the like. As a specific example, the one or more aperture optics 120 may include telescope optics, such as reflectors, lenses, or similar components configured to collect and condition incoming light or to shape and transmit outgoing light. In this way, the one or more aperture optics 120 may condition an optical signal for further processing within the housing 110 or for transmission out of the housing 110.

As further shown in FIG. 1, the planar optical element 125 may be disposed within the housing 110 and positioned away from and not adjacent to the aperture 115 along the optical signal path 140. As used herein, “positioned away from and not adjacent” to the aperture 115 means that one or more other optics, such as the one or more aperture optics 120, are disposed between the aperture 115 and the planar optical element 125 along the optical signal path 140, and/or that the planar optical element 125 is separated from the aperture 115 by at least a threshold distance. The threshold distance may be defined, for example, as a percentage of the aperture diameter 145 of the aperture 115, a percentage of a planar optical element diameter 150 of the planar optical element 125, or another measurable, non-arbitrary distance sufficient to ensure that the planar optical element 125 is not immediately adjacent to the aperture 115. As an example, the threshold distance may be defined as 10% of the aperture diameter 145 of the aperture 115, or 5 millimeters, whichever is greater. This separation may be provided, for example, to allow a size of an incoming light beam (e.g., that includes an optical signal) to be reduced when the light beam reaches the planar optical element 125, such as through the action of intervening optics (e.g., the one or more aperture optics 120) that focus or condition the light beam along the optical signal path 140.

Accordingly, the planar optical element diameter 150 of the planar optical element 125 may be less than the aperture diameter 145 of the aperture 115. This may be the case, for example, because the one or more aperture optics 120 positioned between the aperture 115 and the planar optical element 125 reduce a size of the incoming light beams, thereby allowing the planar optical element 125 to be smaller than the aperture 115. In this way, the planar optical element 125 may enable advanced optical functions in a compact form factor, which is advantageous for reducing the mass and volume of the optical communication assembly 105.

In some implementations, the planar optical element 125 may comprise a diffractive optical element, a refractive element, a metasurface, or the like, and may be configured to manipulate an optical signal, for example by focusing, collimating, diffracting, or expanding the optical signal, or by imparting a spatial or temporal phase change to a wavefront of the optical signal (e.g., by altering the spatial phase profile to achieve lensing or beam shaping, or by modifying the temporal phase to adjust the propagation characteristics of the optical signal without changing its spatial distribution). This manipulation may occur for both received and transmitted optical signals, enabling the planar optical element 125 to function in both reception and transmission modes. Additionally, or alternatively, at least one surface of the planar optical element 125 may be flat, which allows for direct application of the optical coating 130 (e.g., on the at least one surface). For example, the planar optical element 125 may be a diffractive element, a single-sided refractive element, or a metasurface with a flat surface suitable for coating (e.g., by the optical coating 130, as further described herein).

As further shown in FIG. 1, the optical coating 130 may be disposed on a surface, or more than one surface, of the planar optical element 125. The optical coating 130 may have an optical coating diameter 155 that is less than the aperture diameter 145 of the aperture 115 (e.g., because the planar optical element diameter 150 of planar optical element 125 is less than the aperture diameter 145) and may be positioned along the optical signal path 140 such that an optical signal passes through the optical coating 130 before reaching the planar optical element 125 (e.g., when the optical signal enters the housing through the aperture 115).

In some implementations, use of a flat surface of the planar optical element 125 for the optical coating 130 supports more uniform and high-performance coating deposition compared to curved surfaces, which can be difficult to coat with precision. In some implementations, applying the optical coating 130 to a flat surface reduces integration complexity and improves reliability of the optical coating 130 (e.g., to provide a filtering functionality, as described herein) compared to adding a separate filtering component. In some implementations, this approach enables manufacturing of the optical communication assembly 105 by leveraging well-established thin-film coating processes on flat substrates. In this way, technical resources and system reliability are improved by minimizing manufacturing challenges and enabling consistent filtering performance described herein.

As further shown in FIG. 1, the one or more routing optics 135 may be positioned along the optical signal path 140 downstream of the planar optical element 125 and the optical coating 130. The one or more routing optics 135 may be configured to direct, steer, or otherwise manipulate a received optical signal after the optical signal has been conditioned and filtered by the optical coating 130 and the planar optical element 125, for example, by focusing the optical signal onto a detector, coupling the optical signal into a fiber, or directing the optical signal toward additional optical components within the optical communication assembly 105. In some implementations, the one or more routing optics 135 may also be configured to direct or shape an outgoing optical signal for transmission, such as by steering or focusing the optical signal toward the aperture 115 for emission from the optical communication assembly 105 via the planar optical element 125 and the optical coating 130. The one or more routing optics 135 may include mirrors, prisms, lenses, beam splitters, or other optical elements suitable for guiding or distributing an optical signal as required by a specific optical communication application. The inclusion of the one or more routing optics 135 enables flexible system architectures and supports integration with a variety of downstream or upstream optical or optoelectronic components, thereby enhancing the versatility and functionality of the optical communication assembly 105 for both reception and transmission of optical signals.

In some implementations, the optical coating 130 may include a narrowband transmission region and a broadband blocking region configured to attenuate optical signals outside the narrowband transmission region. The narrowband transmission region refers to a spectral range that is sufficiently narrow to allow only desired communication wavelengths to pass through, while the broadband blocking region refers to a spectral range outside the transmission region that is substantially attenuated or blocked by the optical coating 130. For example, the bandwidth of the narrowband transmission region may be less than or equal to the width of a communication band, such as the C-band (e.g., ranging from 1530 nanometers (nm) to 1565 nm, with a width of 35 nanometers) or another communication band relevant to optical communication. The broadband blocking region is designed to suppress or reject optical signals outside the narrowband transmission region, including unwanted background light, ambient noise, or solar radiation. As a specific example, the optical coating 130 may comprise a solar rejection filter configured to transmit a communication wavelength band (e.g., the C-band or another communication band) and block solar radiation and other unwanted wavelengths outside the communication wavelength band.

In some implementations, such a narrow transmission region is achieved using advanced thin-film deposition techniques or multi-layer dielectric stacks tailored for narrowband filtering. In some implementations, the narrowband specification may be selected to match spectral requirements of a particular optical communication protocol or channel. In some implementations, the broadband blocking region of the coating 130 may be engineered to efficiently suppress unwanted background light, such as solar or other out-of-band sources.

In this way, the optical coating 130 may enhance signal-to-noise ratio by providing improved out-of-band rejection, thereby ensuring that only desired optical signals (e.g., communication signals) are transmitted or received by the optical communication assembly 105 while minimizing interference from extraneous optical sources. Further, memory and processing resources are conserved by reducing an amount of unwanted spectral information that must be processed downstream of the optical coating 130 (and the planar optical element 125).

Additionally, use of a flat surface of the planar optical element 125 for the optical coating 130 enables the transmission region to be narrower than would be feasible with a curved optic and coating. For example, when the optical coating 130 is applied to a flat surface, curvature-induced angle shift is absent, which allows a spectral passband of the optical coating 130 to remain tightly centered on a desired wavelength or wavelength range, without broadening to accommodate off-axis rays. In some implementations, this means the optical coating 130 is configured for a communication band with minimal overlap into unwanted spectral regions, thereby reducing noise and improving signal quality. In contrast, curved optics require broader filter bandwidths to compensate for angle-dependent wavelength shifts, which can introduce more background light and degrade signal-to-noise ratio. In some implementations, the narrower filter specification of the optical coating 130 afforded by flat geometries is especially advantageous for FSOC and quantum applications, where high spectral selectivity is critical. In some implementations, filter modeling and manufacturing of the optical coating 130 is simplified, as a flat geometry provides predictable and uniform coating performance across an entire optical surface of the planar optical element 125. Further, processing and memory resources are conserved by minimizing a spectral range of incoming signals requiring analysis and rejection downstream of the optical coating 130 (and the planar optical element 125).

In some implementations, the optical coating 130 may be configured to limit a shift in the transmission band of the optical coating 130 to less than 5 nm over an angle of incidence range of at least plus or minus 15 degrees. For example, when incoming light strikes the optical coating 130 at any angle within plus or minus 15 degrees, a peak transmission wavelength may change by less than 5 nm. In some implementations, this stable transmission characteristic is achieved by optimizing refractive indices and layer thicknesses of coating materials of the optical coating 130 during fabrication. In some implementations, the design may include compensation layers that minimize angular sensitivity, ensuring uniform spectral performance for off-axis optical signals. In some implementations, such stability is important for applications where an angle of incoming light varies due to movement of the optical communication assembly 105 or environmental factors. In some implementations, this configuration enables reliable communication regardless of minor misalignments or motion of the optical communication assembly 105. In this way, network and processing resources are conserved by maintaining consistent filtering performance without requiring frequent recalibration or compensation by downstream electronics.

Additionally, or alternatively, by using a planar optical element 125 with an integrated optical coating 130 that provides a narrowband transmission capability and broadband blocking capability, a required area for blocking unwanted light is reduced compared to other designs that would position large broadband rejection filters positioned at or within the aperture 115. In some aspects, this smaller size directly reduces material usage and overall assembly weight, making the optical communication assembly 105 more suitable for applications where mass is critical (e.g., space-based applications). In some implementations, a throughput of the optical communication assembly 105 is maintained at a high level because the optical coating 130 is positioned at an optimal point along the optical signal path 140, after initial optical signal collection (for an entering optical signal) but before the one or more routing optics 135. In some implementations, overall system complexity and risk of performance degradation are reduced by eliminating a need for a separate, large filter component.

Additionally, or alternatively, at least one of the planar optical element 125 or the optical coating 130 may be configured to modify a polarization state of an optical signal (e.g., a transmitted or received optical signal) that propagates along the optical signal path 140 through the planar optical element 125 and the optical coating 130. For example, the planar optical element 125 may comprise a metasurface designed to enable polarization control, and/or the optical coating 130 may include polarization-selective layers or structures configured to transmit, reflect, or block specific polarization states of the optical signal. In some implementations, both the planar optical element 125 and the optical coating 130 may independently or cooperatively contribute to polarization management, which can include polarization-selective transmission or rejection. In some implementations, this integration allows for more flexible filter design and improved compatibility with protocols that are sensitive to polarization effects. In some implementations, such polarization engineering can also improve signal fidelity and reduce system complexity by eliminating a need for additional polarization-managing components. In this way, processing resources are conserved by embedding polarization control directly within the optical signal path 140, minimizing hardware and software requirements for polarization compensation. For example, at least one of the planar optical element 125 or the optical coating 130 may be specifically configured to modify a polarization state of the optical signal, such as by converting between linear and circular polarization, rotating a polarization axis, or selectively transmitting or blocking a particular polarization state.

Additionally, or alternatively, the planar geometry of the planar optical element 125 and the optical coating 130 facilitates integration of non-optical functional layers, such as tunable or switchable materials and integrated resistive heaters, into the composite optical structure. For example, the optical coating 130 or the planar optical element 125 may comprise a tunable or switchable material, optical properties of which, such as refractive index, transmission characteristics, or filtering wavelength, are adjustable in response to an applied electrical signal, thermal input, or optical stimulus. This enables dynamic modulation of filtering properties, such as shifting a transmission window electronically between 1550 nm and 1555 nm, or adapting filter characteristics for different operational requirements. Additionally, a resistive heater may be integrated into either the planar optical element 125 or the optical coating 130 to provide active temperature control, thereby allowing precise thermal management of the optical properties and ensuring stable performance under varying environmental conditions. The flat surface of the planar optical element 125 simplifies the deposition and patterning of these functional films compared to curved optics, facilitating reliable integration. Embedding these functionalities within the planar optical element 125 or the optical coating 130 eliminates a need for separate heating or modulation components, reduces overall assembly complexity, and enhances reliability.

In some implementations, the planar optical element 125 may comprise an optically transparent substrate, such as glass, silicon, germanium, or a combination of these materials. The planar optical element 125 may further include one or more layers comprising materials that include at least silicon (Si), silicon dioxide (SiO₂), hydrogenated silicon (Si:H), tantalum pentoxide (Ta₂O₅), niobium pentoxide (Nb₂O₅), germanium (Ge), silicon germanium (SiGe), hydrogenated silicon germanium (SiGe:H), niobium tantalum oxide (NbTaOₓ), titanium dioxide (TiO₂), silicon nitride (Si₃N₄), or aluminum nitride (AlN), among other examples. In implementations where the planar optical element 125 includes a metasurface, suitable materials may include silicon nitride, titanium dioxide, or other dielectric materials patterned using lithographic techniques. The planar optical element 125 may have a thickness between 1 mm and 5 mm, or more.

In some implementations, the optical coating 130 may comprise alternating layers of high-index and low-index dielectric materials, for example, Ta₂O₅ and silicon dioxide SiO₂, tailored to achieve a narrowband transmission region and a broadband blocking region as described herein. The optical coating 130 may be realized as a multilayer dielectric stack, such as alternating layers of SiO₂ and TiO₂, and may include 40 to 80 layers with a total thickness of 2 μm to 5μm (e.g., deposited via ion-assisted e-beam evaporation or sputtering). The optical coating 130 may be centered at a communication wavelength band, such as the C-band (1530 nm to 1565 nm), with a passband width of 35 nm or less and an out-of-band attenuation exceeding optical density four (OD4) (>99.99% blocking) at wavelengths outside 1500-1600 nm. For a polarization-selective optical coating 130, layers may be engineered with anisotropic materials such as magnesium fluoride (MgF₂) or aluminum oxide (Al₂O₃). For a tunable or switchable optical coating 130, materials such as barium titanate or indium tin oxide may be included, with electrode structures for electrical modulation. An integrated resistive heater may be realized as a patterned thin-film metallic layer, such as nickel-chromium (NiCr) or gold (Au), with a thickness of 100 nm to 500 nm, and may be integrated on the planar optical element 125 or beneath the optical coating 130, capable of maintaining the optical element at 20-40° Centigrade (C.) with ±0.5° C. stability.

The optical coating 130 may be deposited onto the flat surface of the planar optical element 125 using well-established thin-film deposition techniques, such as electron beam evaporation, ion-assisted deposition, or sputtering. These methods enable precise control of layer thickness and composition, ensuring the desired optical performance and uniformity across the flat surface of the planar optical element 125.

As indicated above, FIG. 1 is provided as an example. Other examples may differ from what is described with regard to FIG. 1. The number and arrangement of devices shown in FIG. 1 are provided merely as examples. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

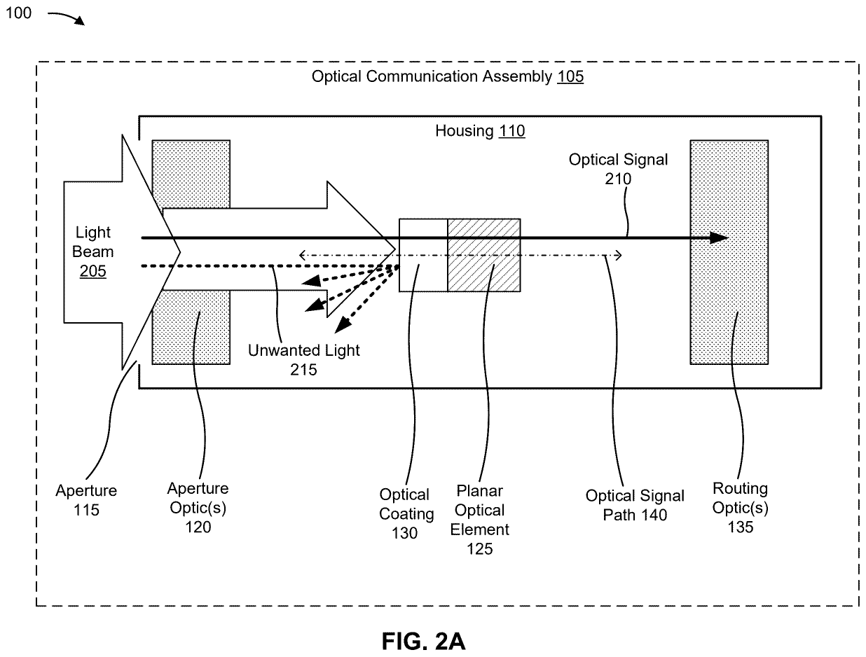

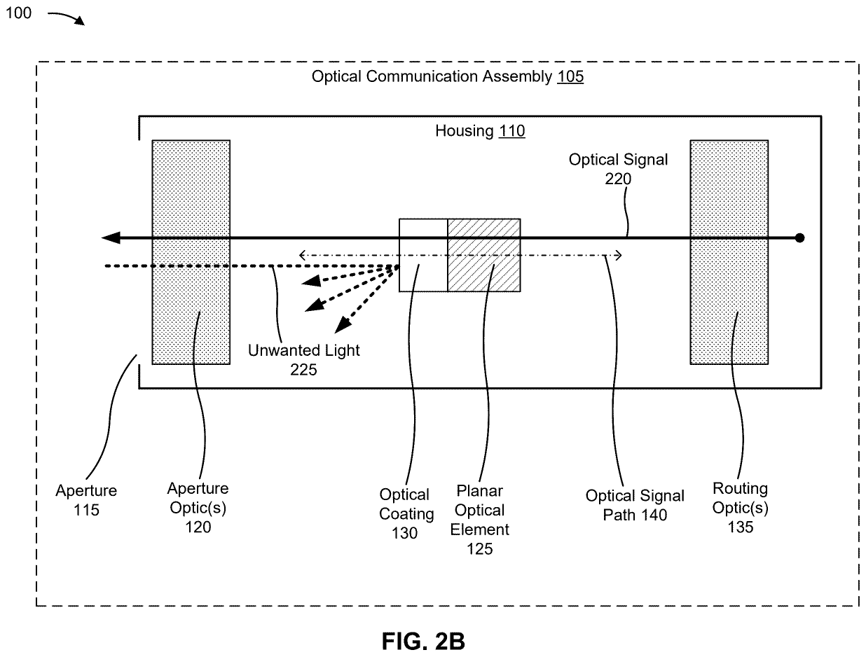

FIGS. 2A-2B are diagrams of example implementations 200 associated with an optical communication assembly with an internal planar optical element and optical coating. As shown in FIGS. 2A-2B, the example implementations 200 comprise the optical communication assembly 105, which includes the housing 110 that has the aperture 115, the one or more aperture optics 120, the planar optical element 125, the optical coating 130, and/or the one or more routing optics 135 described herein in relation to FIG. 1.

As shown in FIG. 2A, the optical assembly 105 may receive a light beam 205 that includes an optical signal 210 and unwanted light 215. The optical signal 210 may be a communication optical signal associated with a communication band, such as a wavelength range used for data transmission in FSOC systems. The unwanted light 215 may include non-signal light, such as sunlight or other environmental light sources that are not part of the intended communication signal. As further shown in FIG. 2A, the light beam 205 may enter the housing 110 of the optical communication assembly 105 via the aperture 115 and may propagate to the one or more aperture optics 120. The one or more aperture optics 120 may direct, focus, or otherwise manipulate the light beam 205 to cause the light beam 205 (that includes the optical signal 210 and the unwanted light 215) to propagate to the planar optical element 125 and the optical coating 130 via the optical signal path 140. Notably, a size (e.g., a width or diameter) of the light beam 205 may be reduced (as compared to a size when entering at the aperture 115) when the light beam 205 reaches the optical coating 130 disposed on the planar optical element 125.

The optical coating 130, which includes a narrowband transmission region associated with the communication band of the optical signal 210 and a broadband blocking region configured to attenuate optical signals outside the narrowband transmission region, allows the optical signal 210 to pass to the planar optical element 125 and blocks the unwanted light 215. The planar optical element 125 then manipulates the optical signal 210 to propagate via the optical signal path 140 to the one or more routing optics 135 and/or to downstream optical or optoelectronic components, such as detectors or signal processing modules. This arrangement provides the benefit of improved signal-to-noise ratio by selectively transmitting the desired optical signal 210 while efficiently blocking the unwanted light 215, thereby enhancing an overall performance and reliability of the optical communication assembly 105.

As shown in FIG. 2B, an optical signal 220 may originate within the optical communication assembly 105 and propagate through the housing 110 along the optical signal path 140. The optical signal 220 may be directed by the one or more routing optics 135, pass through the planar optical element 125 and the optical coating 130, and then traverse the one or more aperture optics 120 to exit the assembly via the aperture 115, for example, for transmission to an external optical communication receiver. The optical signal 220 may be a communication optical signal associated with the communication band, and the optical coating 130 may be configured to allow the optical signal 220 to pass to the one or more aperture optics 120 with minimal attenuation.

In addition, other unwanted light 225, such as non-signal light not associated with the communication band, may enter the housing 110 of the optical communication assembly 105 via the aperture 115 and propagate to the one or more aperture optics 120. The one or more aperture optics 120 may direct the unwanted light 225 along the optical signal path 140 toward the planar optical element 125 and the optical coating 130. The optical coating 130 then blocks the unwanted light 225, thereby preventing it from propagating further within the assembly or interfering with the outgoing optical signal 220. This configuration ensures that only the desired optical signal 220 is transmitted from the optical communication assembly 105, while the unwanted light 225 is efficiently rejected, resulting in improved transmission fidelity, enhanced signal quality, and increased reliability of the optical communication assembly 105.

As indicated above, FIGS. 2A-2B are provided as an example. Other examples may differ from what is described with regard to FIGS. 2A-2B.

The foregoing disclosure provides illustration and description, but is not intended to be exhaustive or to limit the implementations to the precise forms disclosed. Modifications and variations may be made in light of the above disclosure or may be acquired from practice of the implementations.

As used herein, the term “planar optical element” refers to an optical element that manipulates light primarily through features distributed across an overall planar surface, rather than relying on macroscopic surface curvature for its optical function. Such an optical element has at least one substantially flat surface suitable for uniform thin-film coating and predictable optical performance. “Substantially flat” means that the surface exhibits minimal curvature or deviation from a reference plane, such that a maximum deviation does not exceed a specified threshold (for example, less than λ/10, where λ is the design wavelength, or a defined value in micrometers or nanometers over the surface), as measured by standard metrology techniques such as interferometry or profilometry. Conventional lenses, such as plano-convex or plano-concave lenses, are excluded from this definition, even if one side is flat, because their optical function relies on macroscopic curvature. In contrast, planar optical elements, including but not limited to diffractive optical elements, metasurfaces, and refractive elements, achieve their optical function through micro-or nano-scale features whose characteristic length scale is significantly less than the overall optical surface (and/or significantly less than an overall optical aperture of its lens). A non-planar optical element possesses significant curvature or contour, such as spherical or aspherical surfaces, which can result in non-uniform coating deposition and variable optical behavior. The planar geometry described herein is specifically advantageous for achieving stable spectral and angular performance characteristics, as well as reliable and reproducible coating processes.

As used herein, satisfying a threshold may, depending on the context, refer to a value being greater than the threshold, greater than or equal to the threshold, less than the threshold, less than or equal to the threshold, equal to the threshold, not equal to the threshold, or the like.

When a material is referred to by a specific chemical name or formula, the material may include non-stoichiometric variations of the stoichiometrically exact formula identified by the chemical name.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An optical communication assembly, comprising:
a housing having an aperture;
a planar optical element disposed within the housing and positioned along an optical signal path, the planar optical element being located away from and not adjacent to the aperture; and
an optical coating disposed on a surface of the planar optical element, the optical coating having a diameter that is less than a diameter of the aperture.

2. The optical communication assembly of claim 1, wherein the planar optical element comprises at least one of:
a diffractive optical element,
a refractive element, or
a metasurface.

3. The optical communication assembly of claim 1, wherein the planar optical element is configured to manipulate an optical signal that enters the housing through the aperture and propagates along the optical signal path to the planar optical element via the optical coating.

4. The optical communication assembly of claim 3, wherein the planar optical element is configured to focus, collimate, diffract, or expand the optical signal, or to impart a spatial or temporal phase change to a wavefront of the optical signal.

5. The optical communication assembly of claim 3, wherein at least one of the planar optical element or the optical coating is configured to modify a polarization state of the optical signal.

6. The optical communication assembly of claim 1, wherein the optical coating comprises a solar rejection filter configured to transmit a communication wavelength band and to block solar radiation outside the communication wavelength band.

7. The optical communication assembly of claim 1, wherein the optical coating comprises a narrowband transmission region having a bandwidth of 35 nanometers or less and a broadband blocking region configured to attenuate optical signals outside the narrowband transmission region.

8. The optical communication assembly of claim 1, wherein the optical coating is configured to limit a shift in a transmission band of the optical coating to less than 5 nanometers over an angle of incidence range of at least plus or minus 15 degrees.

9. The optical communication assembly of claim 1, wherein the optical coating comprises a tunable or switchable material, optical properties of which are electrically, thermally, or optically adjustable to modify transmission characteristics of the optical coating.

10. The optical communication assembly of claim 1, wherein at least one of the planar optical element or the optical coating comprises an integrated resistive heater configured to control a temperature of at least one of the planar optical element or the optical coating.

11. The optical communication assembly of claim 1, wherein the assembly is configured for use in a satellite or terrestrial free-space optical communication system.

12. An optical communication assembly, comprising:
a housing having an aperture;
a planar optical element disposed within the housing and positioned along an optical signal path, the planar optical element being located away from and not adjacent to the aperture; and
an optical coating disposed on a surface of the planar optical element, the optical coating including a narrowband transmission region and a broadband blocking region configured to attenuate optical signals outside the narrowband transmission region.

13. The optical communication assembly of claim 12, wherein the planar optical element is configured to focus, collimate, diffract, or expand an optical signal that enters the housing through the aperture and propagates along the optical signal path to the planar optical element via the optical coating, or to impart a spatial or temporal phase change to a wavefront of the optical signal.

14. The optical communication assembly of claim 12, wherein at least one of the planar optical element or the optical coating is configured to modify a polarization state of an optical signal that enters the housing through the aperture and propagates along the optical signal path to the planar optical element via the optical coating.

15. The optical communication assembly of claim 12, wherein the optical coating is configured to limit a shift in the narrowband transmission region of the optical coating to less than 5 nanometers over an angle of incidence range of at least plus or minus 15 degrees.

16. The optical communication assembly of claim 12, wherein the optical coating comprises a tunable or switchable material, optical properties of which are electrically, thermally, or optically adjustable to modify transmission characteristics of the optical coating.

17. The optical communication assembly of claim 12, wherein at least one of the planar optical element or the optical coating comprises an integrated resistive heater configured to control a temperature of at least one of the planar optical element or the optical coating.

18. An optical communication assembly, comprising:
a planar optical element disposed within a housing and positioned along an optical signal path, the planar optical element being located away from and not adjacent to an aperture of the housing; and
an optical coating disposed on a surface of the planar optical element, the optical coating including a narrowband transmission region.

19. The optical communication assembly of claim 18, wherein the optical coating is configured to limit a shift in the narrowband transmission region of the optical coating to less than 5 nanometers over an angle of incidence range of at least plus or minus 15 degrees.

20. The optical communication assembly of claim 18, wherein at least one of the planar optical element or the optical coating is configured to modify a polarization state of an optical signal that propagates along the optical signal path to the planar optical element via the optical coating.
